(19) United States
(12) Patent Application Publication
(10) Pub. No.: US 2005/0265028 A1
(43) Pub. Date: Dec. 1, 2005

(54) Backlight and display utilising same

(75) Inventors: Tijsbert Mathieu Henricus Creemers, Nijmegen (NL); Johannes Marra, Eindhoven (NL); Peter Alexander Duine, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Electronics, N.V., Eindhoven (NL)

(21) Appl. No.: 10/527,891

(22) PCT Filed: Aug. 27, 2003
(86) PCT No.: PCT/IB03/03809

§ 371 Date: Mar. 15, 2005

(30) Foreign Application Priority Data
Sep. 18, 2002 (EP) 02078867.5

(51) Int. Cl. F21V 7/00

(52) U.S. Cl. 362/297

(57) ABSTRACT

A backlight including a light guide (10) wherein light from one or more light sources (32) is constrained by total internal reflection and from which light may be output to provide backlighting for a display screen, and a light reservoir (34) for feeding said light guide with light. The light guide has an input surface (20) including incoupling elements (24) rising therefrom and extending into the light reservoir, the incoupling elements having at least three mutually non-coplanar sidewall sections (26) extending transversely from the input surface, each sidewall section covering a different part of the input surface. The light reservoir is arranged such that light passing through one area of the light reservoir is capable of entering the light guide through each of said sidewall sections.

This invention relates to backlights, and it relates especially, though not exclusively, to backlights intended for use with slim-line visual display devices, and to provide thereto light of good uniformity and sufficient brightness.

Devices associated with such backlights are typically capable of use in television displays, monitors and the like. Whatever the proposed use of the display, however, the invention also encompasses displays incorporating, or used in conjunction with, such backlights.

The invention provides special benefits when used in conjunction with, or as part of, a so-called foil display, in which a mobile foil, disposed between a viewing screen and a backlight, is locally attracted, by the application of dynamic voltage waveforms, into contact with the output surface of the backlight at positions where (depending on the picture content to be displayed) light is to be emitted from the display. The local points of contact between the foil and the backlight surface represent bright pixels and the points where no such contact is made are correspondingly dark, and examples of such devices and lighting arrangements therefore can be found for example in WO-A-99/28890; WO-A-00/38163; WO-A-00/50949 and WO-A-01/63588.

A difficulty with slim-line visual displays, including the aforementioned foil displays, arises in coupling enough light into the backlight to illuminate the display with sufficient brightness and uniformity. Typically, the backlight comprises a thin, rectangular plate-like light guide, juxtaposed with the viewed screen of the display, into which light is edge-coupled. The light so coupled into the light guide is in general constrained therein by total internal reflection (TIR), and coupled out only at the locations of pixels which are to appear bright in accordance with the image to be viewed by way of the screen. With such arrangements, light tends to be lost at various locations, but the principal difficulty arises in edge-coupling sufficient light into the light guide. In this respect, the number of lamps that can be used for illumination of the display is limited by the space available at the edge of the light guide, placing a practical limit upon the maximum brightness available.

Moreover, those pixels that are to appear bright extract light from the light guide, thereby limiting the amount of brightness available for other pixels, and adversely affecting the uniformity of the display as regards illumination. This effect of course is dynamic, as it depends upon the image content.

Both of the above effects (limit in overall illumination and dynamic non-uniformity) are particularly noticeable with large displays.

Direct backlighting with diffusers, as may be used for example with liquid crystal displays (LCDs), is not viable with displays using contact light outcoupling, such as foil displays, which rely upon TIR for good contrast.

The invention addresses the problems of brightness and uniformity in backlights utilising TIR, and accordingly aims to provide improved backlights and thus improved displays incorporating them.

According to the invention from one aspect there is provided a backlight including a light guide wherein light from one or more light sources is constrained by total internal reflection and from which light may be output to provide backlighting for a display screen, and a light reservoir for feeding said light guide with light,

the light guide having a substantially planar construction and including an output surface from which light may be output and an opposing input surface disposed to receive said light,

said input surface including incoupling means rising therefrom and extending into the light reservoir, the incoupling means having at least three mutually non-coplanar sidewall sections extending transversely from said input surface, each sidewall section covering a different part of the input surface, the light reservoir being arranged such that light passing through one area of the light reservoir is capable of entering the light guide through each of said sidewall sections.

By this means it will be appreciated that an input arrangement is provided in which input light is spatially mixed and effectively introduced into the light guide so as to ensure TIR propagation from one or more lamps which are not constrained by the need for positioning at or adjacent to an edge of the light guide.

Attempts have previously been made to inject light transversely into a light guide by incorporating light sources into channels in the light guide surface. Such an arrangement is disclosed in German patent application No. 101 02 587.4. In such arrangements, however, the channel dimensions are dictated by the size of the lamps and the light guides so produced tend to be large and heavy. Furthermore, such arrangements exhibit other characteristics which can reduce their suitability for use in displays utilising contact light outcoupling.

The present invention, on the other hand, opens up the opportunity of providing a plurality of lamps in a light-box closely coupled to the input surface of the light guide, with sufficient incoupling elements rising from said input surface to permit the injection of significant amounts of light into the light guide at angles consistent with the promotion of TIR.

In preferred embodiments of the present invention, the incoupling means are formed as an array of incoupling elements rising from the input surface of the light guide. In preferred embodiments, the array may comprise a plurality of substantially parallel, spaced apart, elongate ridge-like members running transversely across the input surface of the light guide. The ridge-like members are preferably substantially rectangular in cross-section and are thus formed with substantially flat outer surfaces and upright sidewalls that are substantially orthogonal to the input surface of the light guide. Alternatively, the incoupling elements may comprise an array of cubes or cylinders, each formed with a respective, substantially flat outer surface and respective upright sidewalls substantially orthogonal to the input surface of the light guide.

Preferably, in any event, the outer surfaces of the incoupling means are rendered substantially absorbent with respect to stray light incident thereon from within the light guide, in as far as this stray light is not constrained inside the light guide by TIR, but substantially reflective with respect to light otherwise incident thereon. This is preferably achieved by depositing, upon each of said outer surfaces, a light-absorbent layer facing the light guide, the light-absorbent layer being substantially not in optical contact with the incoupling elements, followed by a white diffusively reflective coating facing the light reservoir.

In preferred embodiments, reflective means are disposed in spaces between the incoupling means. These may include portions inclined to the sidewalls of said incoupling elements. The intermediate reflective means preferably comprise laminar material configured into a substantially inverted V-shape; said laminar material extending upwardly from locations adjacent to the junctions of the sidewalls of adjacent incoupling elements with said input surface, but having substantially no optical contact with said input surface. This requirement for lack of optical contact between the reflective means and the input surface of the light guide arises because of the desire not to outcouple useful light that is propagating under TIR conditions in the light guide. In this connection, it is preferred that air be disposed between the reflective means and those regions of the input surface of the light guide which that it overlies.

Preferably, surfaces of the intermediate reflective means that face the light reservoir are rendered diffusely reflective of light and surfaces thereof which face towards the light guide are rendered light absorbent. Where the reflective means is a laminar material, respective reflective and absorbent coatings may be applied to the appropriate surfaces thereof.

Preferably the light source or light sources comprise tubular fluorescent lamps disposed with their axes substantially parallel to said input and output surfaces of the light guide. Moreover, where the incoupling elements comprise elongate ridges, the axes of said lamps are preferably disposed parallel to said ridges. In alternative embodiments, the lamps may comprise light emitting diodes (LEDs), or a mixture of various light sources could be used.

A significant advantage of the invention over prior art arrangements is to permit the number and arrangement of light sources to be selected independently of other parameters of the system, thus permitting the overall light input to readily be scaled to meet operational requirements.

The light source or light sources are preferably mounted in a light box with reflective surfaces, preferably white diffusely reflective surfaces, to maximise the amount of light available for injection into the light guide.

In order that the invention may be clearly understood and readily carried into effect, one embodiment thereof will now be described, by way of example only, with reference to the accompanying drawings, of which:

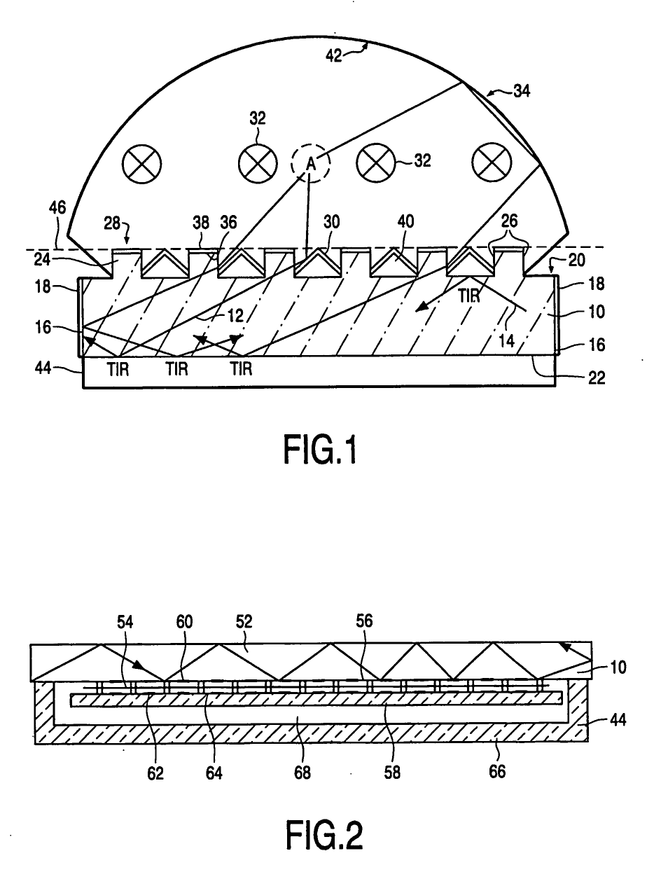

FIG. 1 shows schematically and in cross-sectional view, a part of a display in accordance with one example of the invention; and

FIG. 2 shows in schematic and simplified form a display in accordance with one example of the invention utilising the backlight shown in FIG. 1.

Referring now to FIG. 1, a display is shown including a backlight comprising a light guide 10 and a lightbox 34, and a display screen 44. The display screen 44, to be described in further detail below, includes a matrix of electrodes whereby transmitted light intensities on pixel-sized areas are modulated for generating image frames by means of image scanning circuitry (not shown) in accordance with a received image signal.

Light is intended to propagate within the light guide 10 by TIR, as indicated schematically by the arrowed lines 12 and 14. The light guide 10 is in this embodiment thin and plate-like in construction, formed from a solid transparent material such as glass or a plastic material. The light guide 10 has edges 16 of relatively small dimensions, while its upper and lower surfaces 20 and 22 respectively, as seen in the drawing, are generally rectangular and of relatively large dimensions, commensurate with a display area. The edges 16 of the light guide are provided with a specular reflective coating 18 or a diffuse reflective coating 18, the diffuse reflective coating not being in optical contact with the surface of the edge 16.

The lower surface 22 of the light guide 10, as viewed in the drawing, is substantially planar and constitutes in this example the output surface of the light guide.

The upper surface 20, as viewed in the drawing, constitutes the light input surface and includes a one-dimensional array of rising incoupling elements 24 spaced apart. In this example, each incoupling element 24 comprises an elongated ridge of substantially rectangular cross-section formed as part of, and disposed transversely across, the surface 20. The elements 24 each have sidewalls 26 and an outer surface 28; the sidewalls being, in this embodiment, upright and substantially orthogonal to the input surface 20 of the light guide 10 though this need not necessarily be the case.

In the spaces between the incoupling elements 24 are provided reflective elements 30, which inhibit light entering the light guide through the input surface in the spaces, at angles which would not promote TIR in the light guide 10. The reflective elements 30 in this example comprise laminar members formed into inverted V-shapes, effectively extending from the base of the sidewall 26 of one incoupling element 24 to the base of the sidewall 26 of an adjacent incoupling element 24. The reflective elements 30 are arranged such that there is substantially no optical coupling between the reflective elements 30 and the input surface 20 of the light guide 10 in order to reduce unwanted outcoupling of light propagated by TIR in the light guide 10.

An array of light sources such as tubular fluorescent lamps 32 is disposed in a lightbox 34 and closely coupled to the input surface 20 of the light guide 10.

The incoupling elements 24 may be configured in various different formats and, instead of being formed as a one-dimensional array of elongated ridges of rectangular profile, may alternatively be formed, for example, as a two-dimensional array of upstanding post-like elements such as cubes or cylinders. In any event, however, the sidewalls 26 are configured to provide the sole access for light from the lightbox 34 into the light guide 10, and vice-versa. The endwalls 28 of the incoupling elements are first provided with a light-absorbing coating layer such as a black layer 36 that substantially does not optically couple with the incoupling elements 24 and on top of that is provided with a reflective coating 38 which is preferably a white diffuse reflective coating. The purpose of the coating 36 is to absorb any stray light, incident from within the light guide 10 and not constrained within the light guide by means of TIR, that strikes the outer surface 28 since such light, if it were allowed to continue by a back-reflection from the outer surface 28, would not be subject to TIR and thus might emerge as unwanted stray light from an endwall 22. The reflective coating 38 inhibits light incident from the light box 34 from entering the light guide at angles which would not promote TIR in the light guide, and redirects such incident light back into the light box 34.

Likewise, the reflective elements 30 are provided with a reflective coating, preferably a white diffuse reflective coating, on the surface that faces the lamps and with a black absorbent coating on its surface that faces the light guide 10. Moreover, air is disposed in the area 40 between the reflective elements and the light guide to avoid optical coupling between the reflective elements and the light guide surface 20 and thus the outcoupling of useful light that is propagating in the light guide under TIR conditions.

The lightbox 34 is coated with diffusive white reflective material on its internal surface 42, so as to maximize the amount of light from the lamps that is constrained within, and thus usable by the system.

Instead of, or in addition to, the array of tubular fluorescent lamps 32, other light sources such as LEDs may be used within the lightbox 34.

Where tubular fluorescent lamps are used, their axes preferably run parallel to the surface 20 and to the long axes of the incoupling elements 24, where these are elongated in form. There is no direct correlation between the number of light sources used and either the number of incoupling elements provided or the dimensions of the light guide; the various values and dimensions can be arranged to suit the operating requirements of the system as a whole.

As shown in FIG. 1, the light reservoir formed by the lightbox 34 extends further from the input surface 20 of the light guide than the incoupling elements 24. This allows spatial mixing in the light box so that light passing through one area, such as area A shown in a dotted circle in FIG. 1, is capable of entering the light guide through each of the incoupling elements 24, thus providing homogenization of the input light. For illustrative purposes, in FIG. 1, light from the area A within the light reservoir formed by the lightbox 34 is shown as entering the light guide 10 via three different incoupling elements 24.

There is sufficient space in the lightbox, and the endwalls are sufficiently small in height, for the light sources 32 to be spaced remote from the endwalls 28 in a direction away from the plane of the light guide. As shown in FIG. 1, the endwalls extend into the lightbox 34 to an extent defined by plane 46 shown as a dotted line. The light sources are placed further from the light guide 10 than the plane 46, thus allowing the light sources to be arranged in a desired configuration independently of the arrangement of the incoupling elements 34. Conversely, the incoupling elements 34 may also be arranged in a desired configuration independently of the arrangement of the light sources 32. Preferably, the number of incoupling elements 34 is greater than the number of light sources, to provide increased degree of homogenization for a given number of light sources. In any case, the pattern in which the light sources are arranged in a direction parallel to the plane of the light guide does not need to correspond as regards pitch with the pattern in which the incoupling elements are arranged in the same direction.

The reflective elements 30 need not provide tilted reflective surfaces as shown in the drawing and can take any convenient and practical form, bearing in mind their intended use to divert light into the light guide 10 through the sidewalls 26 of the incoupling members 24 and the requirement that substantially no optical coupling should exist between the reflective elements 30 and the input surface 20 of the light guide. The sidewalls are preferably substantially orthogonal to the input surface 20 though, as previously mentioned, this is not essential and they may be disposed at other orientations.

FIG. 2 shows in further detail and schematically a foil display screen, associated with a backlight as illustrated in FIG. 1. For simplicity of illustration, the light input arrangement for the light guide 10 is omitted in FIG. 2. It should be appreciated that the light sources 34 are continuously activated during the operation of the display screen. The display screen is of the kind described in international patent applications WO-A-99/28890; WO-A-00/38163; WO-A-00/50949 and WO-A-01/63588, the contents of which relating to the display screen are incorporated herein by reference.

The display screen 44 comprises a flexible member 54, typically a light-scattering polymeric foil, disposed between the output surface 56 of the backlight 52 and a transparent plate 58. Electrode systems 60 and 62 are arranged, respectively, on the output surface 56 and the inner surface 64 of the transparent plate 58. By locally generating a potential difference between the electrodes 60, 62, and the foil 54, by applying voltages to the electrodes and the foil, forces are locally exerted on the foil at each potential contact point (corresponding to a pixel of the display) sufficient to either press the foil against the output surface 56 or keep it away from it, depending on whether, in accordance with the content of an image to be displayed, light is or is not to be coupled out of the backlight to emerge from the display at that point. It will be appreciated that the applied voltages are used to scan the contact point relative to the plates in a two-dimensional pattern, such as a conventional television raster.

The display screen 44 also has a covering screen element 66 which is configured so as to form an airtight connection with the backlight 52, whereby the space 68 can be evacuated.

While the present invention has particular applicability to the foil display described herein, it should be appreciated that the backlight described herein can be used with any kind of display for which it may be suited.

The invention encompasses display apparatus, such as broadcast/cable TV receivers, specialist monitoring equipment, for medical, technical or forensic purposes for example, monitors for personal computers, and displays for portable electronic devices such as mobile telephones and personal digital assistants.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in the accompanying claims.

1. A backlight including a light guide wherein light from one or more light sources is constrained by total internal reflection and from which light may be output to provide backlighting for a display screen, and a light reservoir for feeding said light guide with light,
the light guide having a substantially planar construction and including an output surface from which light may be output and an opposing input surface disposed to receive said light,
said input surface including incoupling means rising therefrom and extending into the light reservoir, the incoupling means having at least three mutually non-coplanar sidewall sections extending transversely from said input surface, each sidewall section covering a different part of the input surface, the light reservoir being arranged such that light passing through one area of the light reservoir is capable of entering the light guide through each of said sidewall sections.

2. A backlight according to claim 1, further including intermediate reflective means disposed in spaces between said sidewall sections and configured to reflect light impinging thereon from said light reservoir away from parts of the input surface in said spaces.

3. A backlight according to claim 2, wherein surfaces of said intermediate reflective means which face away from the light guide are rendered diffusely reflective to light.

4. A backlight according to claim 2 or 3, wherein surfaces of said intermediate reflective means which face the light guide are rendered light absorbent.

5. A backlight according to claim 2, 3 or 4, wherein a gas is provided between the intermediate reflective means and those regions of the input surface of the light guide which it overlies.

6. A backlight according to any preceding claim, wherein the incoupling means further include endwall sections spanning the respective sidewall sections, said endwall sections being provided with reflective means configured to reflect light impinging thereon from said light reservoir away from the endwall sections.

7. A backlight according to claim 6, wherein surfaces of said endwall reflective means that face away from the light guide are rendered diffusely reflective to light.

8. A backlight according to claim 6 or 7, wherein surfaces of said endwall reflective means which face the light guide are rendered light absorbent.

9. A backlight according to any preceding claim, wherein said one or more light sources are located in said light reservoir.

10. A backlight according to any preceding claim, wherein said one or more light sources are spaced remote from said incoupling means in a direction away from the plane of the light guide.

11. A backlight according to claim 10, wherein the pattern in which the light sources are arranged in a direction parallel to the plane of the light guide does not correspond as regards pitch with the pattern in which the incoupling elements are arranged in the same direction.

12. A backlight according to claim 11, wherein the incoupling means comprise a plurality of incoupling elements arranged over the input surface.

13. A backlight according to claim 12, wherein said incoupling elements comprise a plurality of elongate ridge-like members transversely spaced in one direction across the input surface of the light guide.

14. A backlight according to claim 13, wherein the ridge-like members are substantially rectangular in cross-section, having substantially flat endwalls and upright sidewalls that are substantially orthogonal to the plane of the light guide.

15. A backlight according to claim 12, wherein the incoupling elements comprise a plurality of members spaced in two orthogonal directions across the input surface of the light guide.

16. A backlight according to any of claims 12 to 15, wherein the height of each said incoupling element, measured perpendicular to the plane of the light guide, is at least as great as a width thereof measured parallel to the plane of the light guide.

17. A backlight according to any preceding claim, wherein the one or more light sources comprise one or more tubular fluorescent lamps disposed with their axes substantially parallel to said input and output surfaces of the light guide.

18. A backlight according to claim 17, as dependent on claim 13 or claim 14, wherein the axis or axes of said one ore more lamps are disposed parallel to said ridges.

19. A backlight according to any of claims 1 to 16, wherein the one or more light sources comprise one or more light emitting diodes.

20. A backlight according to any preceding claim, wherein a mixture of various types of light sources is used.

21. A backlight according to any preceding claim, wherein the light reservoir is formed in a light box with white diffusely reflective inner surfaces.

22. A display for image display, including a backlight according to any preceding claim.

23. A display according to claim 22, the display comprising a screen configured to display images; the display screen comprising a mobile element disposed adjacent to said backlight, and means utilizing dynamic voltage waveforms for locally attracting said mobile element into contact with the output surface of the backlight at positions where, depending on the picture content to be displayed, light is to be emitted from the display.
